(19) United States
(12) Patent Application Publication
(10) Pub. No.: US 2005/0071217 A1
(43) Pub. Date: Mar. 31, 2005

(54) Method, system and computer product for analyzing business risk using event information extracted from natural language sources

(75) Inventors: Bethany Kniffin Hoogs, Niskayuna, NY (US); Jennifer Mary Corman, Latham, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/676,928

(22) Filed: Sep. 30, 2003

(51) Int. Cl. G06F 17/60

(52) U.S. Cl. 705/10; 705/1

(57) ABSTRACT

Method, system and computer product for analyzing business risk using event information extracted from natural language sources. In this invention, articles each containing qualitative business event information relevant to a target business entity are retrieved. A structured events record of details for the qualitative business event information is extracted from the articles. The structured events record is applied to a business risk model that uses temporal reasoning to map qualitative business event information to business risk. The business risk model determines the business risk of the target business entity based on temporal proximity and order of the qualitative business event information in the structured events record.

### BACKGROUND OF THE INVENTION

This invention relates generally to monitoring the financial health of a business entity and more specifically, to analyzing business risk using event information extracted from natural language sources.

There are several commercially available tools that permit financial analysts to analyze the risk that a business entity will default on its financial commitments. Typically, these tools use quantitative financial data such as net income, total revenue, and earnings before interest, tax, depreciation and amortization (EBITDA), which are available in financial statements, to generate a risk score that indicates a likelihood of default. There are several disadvantages with using these tools to analyze the risk that a business entity will default on its financial commitments. One particular disadvantage is that the quantitative financial data is only available at certain times of the year, typically when an entity releases its financial statements. A business entity may be well on its way into default before a financial analyst can analyze the quantitative financial data in the next financial statement. Even if the quantitative financial data were available in a timelier manner, the above commercial tools have the disadvantage that they do not necessarily consider all forms of information that may indicate business risk. For example, these tools do not consider qualitative business event information that may arise before the release of a financial statement such as the Securities Exchange Commission (SEC) initiating an investigation of an entity, a Chief Financial Officer (CFO) or auditor resigning from the entity, debt restructuring or an entity losing several significant customers. Since the financial statements are released periodically, there may be a time lag between the occurrence of a business event and the reporting of new financial data, which the commercially available tools cannot take into account.

In order to account for the disadvantages associated with the above commercial tools, financial analysts typically monitor qualitative business event information of a business entity by analyzing information in publicly available sources. In particular, financial analysts manually read through business, industry and trade news publications for qualitative business event information that relates to a business entity and then use their judgment to predict the business risk of the entity. This manual process of collecting and analyzing qualitative business event information is ad hoc in both its methodology and coverage and may result in missed events of importance and missed recognition of trends that indicate overall business risk. In addition, this process is very time consuming, especially with the increasing amount of information available on the Internet and in other media.

Therefore, there is a need for a methodology that can collect and analyze qualitative business event information for a business entity from various sources and determine the business risk of the entity from the information.

### BRIEF DESCRIPTION OF THE INVENTION

In one embodiment, there is a method and a computer readable medium to analyze business risk using qualitative business event information. In this embodiment, a plurality of articles each containing qualitative business event information relevant to a target business entity is retrieved. A structured events record of details for the qualitative business event information is extracted from the plurality of articles. The structured events record is applied to a business risk model that uses temporal reasoning to map qualitative business event information to business risk. The business risk model determines the business risk of the target business entity based on temporal proximity and order of the qualitative business event information in the structured events record.

In a second embodiment there is a method and a computer readable medium to analyze business risk of a target business entity from qualitative event business information. In this embodiment, a plurality of articles each containing qualitative event information relevant to the target business entity is received. The retrieved articles contain keywords and text patterns that are representative of events of interest for the target business entity and are within a reasonable proximity to the target business entity. Each sentence within a paragraph of text from an article that contains keywords and text patterns is parsed into component parts of speech and grammar structure. Event details and relationships between events and the target business entity is extracted from the component parts of speech and grammar structure. A structured events record is generated from the extracted event details and relationships. The structured events record are compared to templates of pattern events, wherein each template comprises a number and type of events that form a pattern in an event category and temporal constraints that exist between the events. Temporal based reasoning is used to identify templates of pattern events that match the structured events record. A probability of risk measure based on the degree of match between the identified templates of pattern events and the structured events record is then generated.

In a third embodiment, there is a method for monitoring business risk of a target business entity using qualitative event business information. In this embodiment, a plurality of natural language sources is searched for articles mentioning the target business entity. A plurality of articles each containing qualitative event business information relevant to the target business entity is then retrieved. The retrieved articles contain keywords and text patterns that are representative of events of interest for the target business entity and are within a reasonable proximity to the target business entity. Next, it is determined, whether any of the retrieved articles contain unanalyzed qualitative event business information. For articles that contain unanalyzed qualitative event business information, each sentence within a paragraph of text from the article is parsed into component parts of speech and grammar structure. Event details and relationships between events and the target business entity are extracted from the component parts of speech and grammar structure. A structured events record is then generated from the extracted event details and relationships. The structured events record is compared to templates of pattern events, wherein each template comprises a number and type of events that form a pattern in an event category and temporal constraints that exist between the events. Temporal based reasoning is used to identify templates of pattern events that match the structured events record. A probability of risk measure based on the degree of match between the identified templates of pattern events and the structured events record is then generated.

In another embodiment, there is a system for analyzing business risk from qualitative business event information. The system comprises a search component configured to search and retrieve a plurality of articles each containing qualitative business event information relevant to a target business entity. Also, the system comprises an extraction engine component configured to extract a structured events record of details of the qualitative business event information retrieved from the plurality of articles. In addition, the system comprises a business risk model component configured to map the structured events record of the target business entity to a business risk measure. The business risk model component determines the business risk measure based on temporal proximity and order of the qualitative business event information in the structured events record.

In a fifth embodiment, there is a system for analyzing business risk of a target business entity from qualitative event business information. The system comprises a text pattern database defining a set of keywords and text patterns that are representative of events of interest. A search component is configured to search a plurality of natural language sources and retrieve a plurality of articles each containing keywords and text patterns defined in the text pattern database. An extraction engine component is configured to extract a structured events record from the plurality of articles. The extraction engine component comprises a grammar parsing tool configured to receive paragraphs of text containing the keywords and text patterns from each of the plurality of articles and parse each sentence within the paragraphs into component parts of speech and grammar structure. The extraction engine component also comprises a semantic analysis tool configured to extract event details and relationships between events and the target business entity from the component parts of speech and grammar structure. The system also comprises a pattern events database that comprises templates of pattern events, wherein each template comprises a number and type of events that form a pattern in an event category and temporal constraints that exist between the events. A pattern analyzer is configured to use temporal reasoning to compare the structured events record to the templates of pattern events and identify templates of pattern events that match the structured events record.

### BRIEF DESCRIPTION OF THE DRAWINGS

FIG. 1 shows a schematic of a general-purpose computer system in which a system for analyzing business risk using event information may operate;

FIG. 2 shows a high-level component architecture diagram of the system for analyzing business risk using event information;

FIG. 3 is an example of a pattern of events that can be stored in the events and patterns database shown in FIG. 2;

FIG. 4 shows an architectural diagram of a system that implements the business risk analysis system shown in FIG. 2;

FIG. 5 is a flowchart describing some of the processing functions performed by the system shown in FIG. 4;

FIG. 6 shows a system for analyzing business risk from event information by using case-based reasoning;

FIG. 7 is a flowchart describing some of the processing functions performed by the system shown in FIG. 6;

FIG. 8 shows a system for analyzing business risk from event information by using a Bayesian belief network;

FIG. 9 is a flowchart describing some of the processing functions performed by the system shown in FIG. 8; and

FIG. 10 shows a business risk analysis system suitable for monitoring business risk of business entities on a scheduled basis; and

FIG. 11 is a flowchart describing some of the processing functions performed by the system shown in FIG. 10.

### DETAILED DESCRIPTION OF THE INVENTION

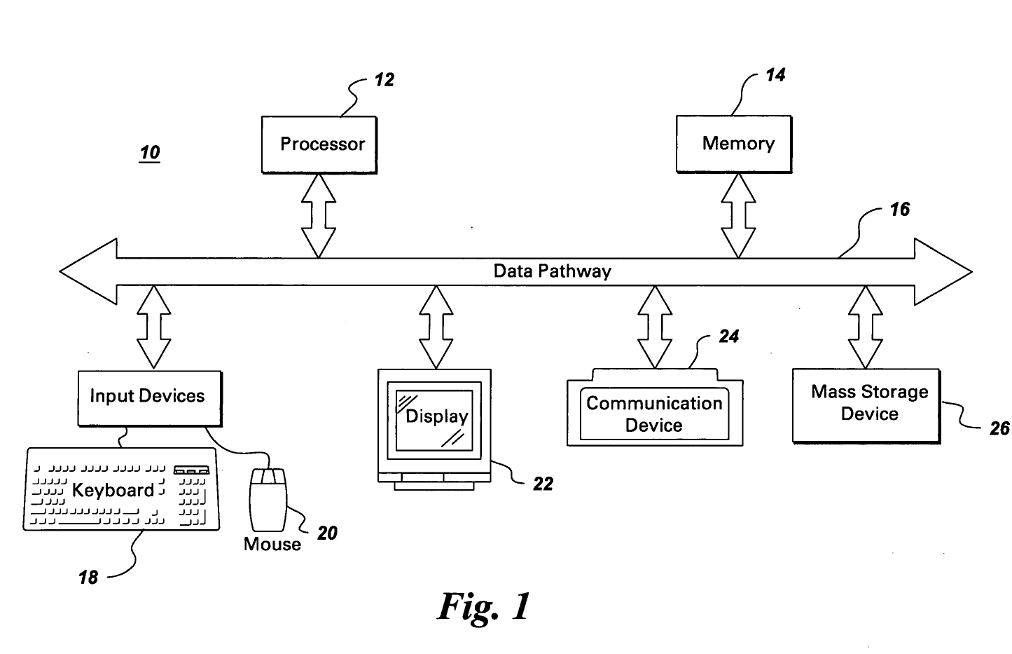

FIG. 1 shows a schematic of a general-purpose computer system 10 in which a system for analyzing business risk using event information may operate. The computer system 10 generally comprises at least one processor 12, a memory 14, input/output devices, and data pathways (e.g., buses) 16 connecting the processor, memory and input/output devices. The processor 12 accepts instructions and data from the memory 14 and performs various data processing functions of the business risk analysis system like searching natural language sources, proximity checking, data extraction, modeling and data analysis. The processor 12 includes an arithmetic logic unit (ALU) that performs arithmetic and logical operations and a control unit that extracts instructions from memory 14 and decodes and executes them, calling on the ALU when necessary. The memory 14 stores a variety of data computed by the various data processing functions of the business risk analysis system. The memory 14 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices. The information in the memory 14 might be conveyed to a human user through the input/output devices, and data pathways (e.g., buses) 16, in some other suitable manner.

The input/output devices may comprise a keyboard 18 and a mouse 20 that enter data and instructions into the computer system 10. Also, a display 22 may be used to allow a user to see what the computer has accomplished. Other output devices may include a printer, plotter, synthesizer and speakers. A communication device 24 such as a telephone, cable or wireless modem or a network card such as an Ethernet adapter, local area network (LAN) adapter, integrated services digital network (ISDN) adapter, or Digital Subscriber Line (DSL) adapter, that enables the computer system 10 to access other computers and resources on a network such as a LAN or a wide area network (WAN). A mass storage device 26 may be used to allow the computer system 10 to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media.

The above-described computer system 10 can take the form of a hand-held digital computer, personal digital assistant computer, notebook computer, personal computer, workstation, mini-computer, mainframe computer or supercomputer.

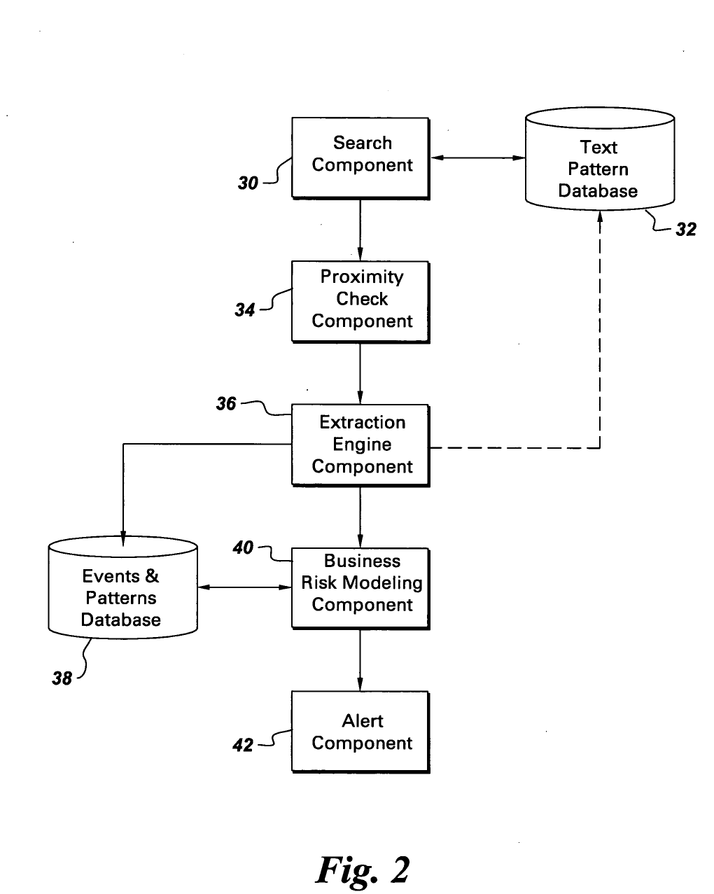

FIG. 2 shows a high-level component architecture diagram of a business risk analysis system 28 that can operate on the computer system 10 of FIG. 1. The business risk analysis system 28 generally comprises a search component 30, a text pattern database 32, a proximity check component 34, an extraction engine component 36, an events and patterns database 38, a business risk model component 40 and an alert component 42. One of ordinary skill in the art will recognize that the business risk analysis system 28 is not necessarily limited to these elements. It is possible that the business risk analysis system 28 may have additional elements or fewer elements than what FIG. 2 shows.

The search component 30 is configured to search and retrieve a plurality of articles each containing qualitative business event information relevant to a target or specific business entity. Qualitative business event information are verbal or narrative pieces of data that are representative of certain business and financial actions or occurrences that are associated with or affect a business entity such as a public or private corporation or a partnership. In this invention, the search component 30 preferably searches for qualitative business event information that pertains to the business risk of a business entity. More specifically, business and financial events that reflect the behavioral symptoms and/or catalysts of business and financial stress rather than quantitative indicators such as financial ratios, debt ratios, stock price, etc. An illustrative, but non-exhaustive list of qualitative business event information for a business entity is defaults on credit or loan agreements, bankruptcy rumors, bankruptcy, debt restructure, loss of credit, target of SEC actions, restatement of previously published earnings, change of auditors, management changes, layoffs, wage reductions, company restructures, refocused objectives, mergers and acquisitions, government changes and industry events that may impact a business. These examples are suitable for analyzing default risk, but the teachings of this invention are applicable to analyzing other types of business risk such as underwriting risk and portfolio risk.

Generally, the search component 30 searches on-line news sources such as YAHOO! News, FindArticles.com, etc., commercial news sources such as WALL STREET JOURNAL, BLOOMBERG, etc., and business, trade and industry publications such as JOURNAL OF ACCOUNTANCY, ECONOMIST, MODERN MACHINE SHOP, etc. for articles that contain qualitative business event information that pertain to a target business entity. The search component 30 is not limited to searching the above sources and one of ordinary skill in the art will recognize that the search component can search any natural language source containing qualitative business event information in the form of structured and unstructured text. For example, data stores such as DUN AND BRADSTREET, SEC's EDGAR and NEXIS-LEXIS are other possible sources of qualitative business event information. Also, the search component 30 is not limited to searching natural language sources that are available solely via the Internet. One of ordinary skill in the art will recognize that the search component 30 can search natural language sources that reside in other local or remote data stores.

The search component 30 performs an initial search by using the search facility associated with the on-line new sources, commercial news sources or publication sources. Typically, the search component 30 utilizes the search facility through a web browser, which enters the name of the target business entity and any keywords. Once a target business entity and keywords have been entered as search criteria, the search facility returns a list of links to articles that mention the target business and keywords. The search component 30 then scans each of the articles returned and determines whether they contain keywords and text patterns that are representative of events of interest for the target business entity. In order to filter the articles for keywords and text patterns, the search component 30 accesses the text pattern database 32 to determine whether the articles contain keywords and text patterns that are representative of events of interest for the target business entity.

The text pattern database 32 is preferably a domain ontology that defines a set of keywords and text patterns that are representative of events of interest. The keywords generally are words that trigger recognition of a specific event of interest. An illustrative, but non-exhaustive list of some keywords and phrases that trigger recognition of a specific event of interest that pertains to business risk includes “bankrupt”, “RICO” (racketeering, influence, and corruption), “management takeover” or “SEC”. The text patterns are word patterns that trigger recognition of a textual description of a specific event of interest. An example of a text pattern is “restate*earnings”, where the asterisk * represents a wildcard, allowing this pattern to match permutations of the pattern, such as “restated the prior year's earnings,” “restate 1998 and 1999 earnings”, and “1999 earnings were restated”. These examples are just a few of the many possibilities of text patterns that one can store in the database 32. The keywords and text patterns can be preferably in an XML format, however, one of ordinary skill in the art will recognize that other formats can be used such as resource bundles, CSV files or tables in relational databases. In addition, the text pattern database 32 is scalable so that one can add new keywords and text patterns that describe events not originally contemplated when first implementing the system.

The proximity check component 34 receives a list of all of the articles that the search component 30 determined had keywords and text patterns that were representative of events of interest for the target business entity. The proximity checking component 34 is configured to ascertain whether the keywords and text patterns in the articles are within a reasonable proximity to the target business entity. The proximity checking component 34 uses a plurality of proximity rules and compares them to the keywords and text patterns to identify whether they are likely related to the target business entity. An example of a proximity rule is that a company must appear within 60% of the sentence length of one of the words in the patterns. The proximity checking component 34 can also generate a confidence measure for each article ascertained to have keywords and text patterns within a reasonable proximity to the target business entity. The confidence measure is an indication of the belief that the article contains an event of interest that is relevant to the target business entity. For example, the proximity checking component 34 will generate a high level of confidence measure for articles found to contain relevant events of interest. Commonly assigned U.S. patent application Ser. No. 10/218,620, entitled Method And System For Event Phrase Identification and commonly assigned U.S. patent application Ser. No. 10/336,545, entitled Method And System For Identifying And Matching Companies To Business Event Information, provide a more detailed discussion of the operation of the proximity checking component 34. The proximity checking component 34 will remove articles from consideration that do not have keywords or text patterns within a reasonable proximity and will output the relevant paragraphs from the articles that it determines to be within a reasonable proximity to the extraction engine component 36.

The extraction engine component 36 is configured to extract a structured events record of details of the qualitative business event information retrieved from each of the relevant paragraphs outputted by the proximity checking component 34. The extraction engine component 36 includes a grammar parsing tool configured to parse each sentence within the received paragraphs into component parts of speech (e.g., nouns, verbs, adjectives, etc.) and grammatical structure. The extraction engine component 36 also includes a semantic analysis tool configured to extract event details and relationships between events and the target business entity from the component parts of speech and grammar structure. In particular, the semantic analysis tool is configured to locate the target business entity and keywords that are representative of events of interest in each sentence, identify roles of the keywords in the sentences, and determine relationships between events and the target business entity based on the roles of the keywords. In essence, the semantic analysis tool serves to validate the event-entity relationships that the proximity checking component found to be within reasonable proximity or to find possible errors, and to ensure that there exists a true semantic dependency between the terms of interest. If there is a proximity or semantic-based error, then the semantic analysis tool will discard the respective paragraph and associated article from further consideration. The semantic analysis tool is also configured to identify sense and direction of the events in the sentences. Determining the sense allows one to distinguish between phrases such as “the company declared bankruptcy” and the “company will not declare bankruptcy”. Determining direction allows one to properly identify roles in events such as acquisitions, in which one entity is the acquirer and the other is the acquiree. One of ordinary skill in the art can develop code so that the grammar parsing tool and the semantic analysis tool can perform the above functionality or modify commercially available tools such as CONNEXOR and INFACT to perform these functions.

All of the information determined by the grammar parsing tool and the semantic analysis tool are put into the structured events record. The events record is a data structure consisting of slots for the elements of interest in an event, such as the subject, sense and object. The events record includes information such as an event category (e.g., management change, SEC action, bankruptcy, etc.), event keywords within each sentence of an article, roles of the keywords within each sentence, relationships between the events and the target business entity and sense and direction of the events. One of ordinary skill in the art will recognize that the events record is not necessarily limited to these items and it is possible to have additional items or fewer. Also, one of ordinary skill in the art can develop code to perform functions necessary to generate the events record or modify commercially available tools such as ATTENSITY and CLEARFOREST to perform these functions.

After generating the events record, the extraction engine component 36 stores it in the events and patterns database 38. In addition to storing event records, the events and patterns database 38 stores templates of pattern events. Each template of pattern events comprises a number and type of events that form a pattern in an event category and temporal constraints that exist between the events. The event types in each template refer to the event categories that are extracted and each category can reflect different levels of granularity. For example, one template may include an event of “Chief Executive Officer (CEO) Change” and another template can include an event of “Management Change” indicating that any top-level executive can fit the pattern. In the events and patterns database 38, the temporal constraints are represented using Allen algebra relations, which are well known to people skilled in the art and used to represent qualitative information about relative positioning of intervals and to perform deduction of new information about the position of intervals. It consists of a set of thirteen basic relations representing all of the possible relative positions of two intervals, and three “algebraic” operations. A more detailed discussion of the Allen algebra relations is set forth in Allen, “Maintaining knowledge about temporal intervals”, Communications of the ACM, 26(11), 832-843, 1983.

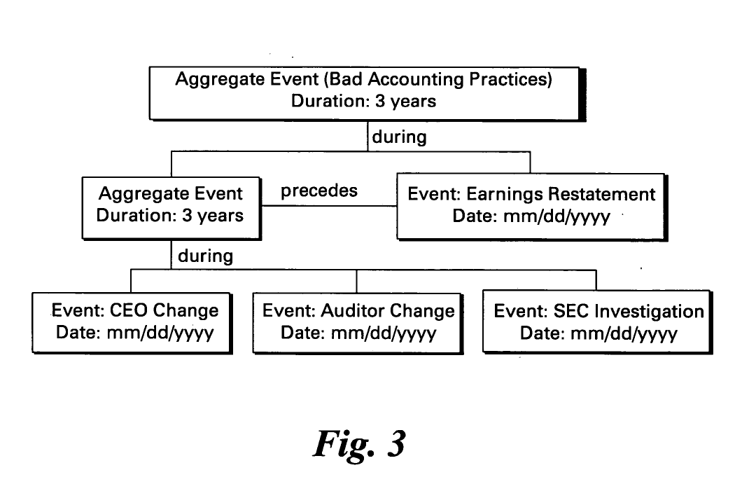

In this invention, the events and patterns database 38 can store aggregate events, which are events that are inferred and not observed. FIG. 3 is an example illustrating how aggregate events can be used to group events in a pattern to apply an overall temporal constraint. In particular, FIG. 3 illustrates an example of events that could occur for a “Bad Accounting Practice” category or pattern. In this example, the pattern includes three concrete events (i.e., a CEO Change, Auditor Change and SEC investigation) that occur in any order within three months and are followed by a restatement of earnings within three years. For this pattern, relationships between events specify temporal constrains, such as that the three events at level two (i.e., CEO Change, Auditor Change and SEC investigation) must occur during the top-level aggregate event (i.e., Bad Accounting Practices), which specifies a duration of three years. One of ordinary skill in the art will recognize that the events and patterns database 38 can store other events such as an abstract disjoint event, which groups events in an “or” relationship.

Referring back to FIG. 2, the business risk model component 40 receives the events record generated by the extraction engine component 36. The business risk model component 40 is configured to map the events record of the target business entity to a business risk measure. In particular, the business risk model component 40 determines the business risk measure based on temporal proximity and temporal order of the qualitative business event information in the structured events record. Temporal proximity is the amount time there is between events. The larger the amount of time that there is between events is an indication that there is less of chance that they are part of a pattern. For example, if a CEO of a company resigns and then 10 years later the entity shows signs of financial stress, it is unlikely that the CEO resignation a decade earlier contributed to the current business status. Temporal order is the specific time and order of events that invoke a pattern.

The business risk model component 40 determines the business risk measure based on temporal proximity and temporal order of events by comparing the structured events record to the templates of pattern events stored in the database 38. The business risk model component 40 then identifies templates of pattern events that match the structured events record. The business risk model component 40 will generate a probability of risk measure based on the degree of match between the identified templates of pattern events and the structured events record. The business risk model component can use case-based reasoning or a Bayesian belief network to perform these functions. Below is a more detailed discussion of systems that use case-based reasoning and a Bayesian belief network. This invention is not limited to these techniques and one of ordinary skill in the art will recognize that the business model component 40 may use other models that employ hidden Markov models, Markov random fields, expert-based evidentiary reasoning, neural networks, Dempster-Shafer theory, or a rule-based reasoning, as well as other types of deliberative learning.

The alert component 42 is configured to generate an alert when the business risk model component 40 determines that the risk of the target business entity has reached a predetermined threshold. For example, if the business risk model component 40 determines that there is an 80% chance that the pattern template matches the events record, then the alert component 42 will send out an alert. The alert could include an email to the user such as a financial analyst or it could be a passive type of alert that prompts the analyst to look further into these events. The predetermined threshold will depend on which type of model is used. One of ordinary skill in the art will recognize that the alert component 42 may use other thresholds to generate an alert and other forms of notification.

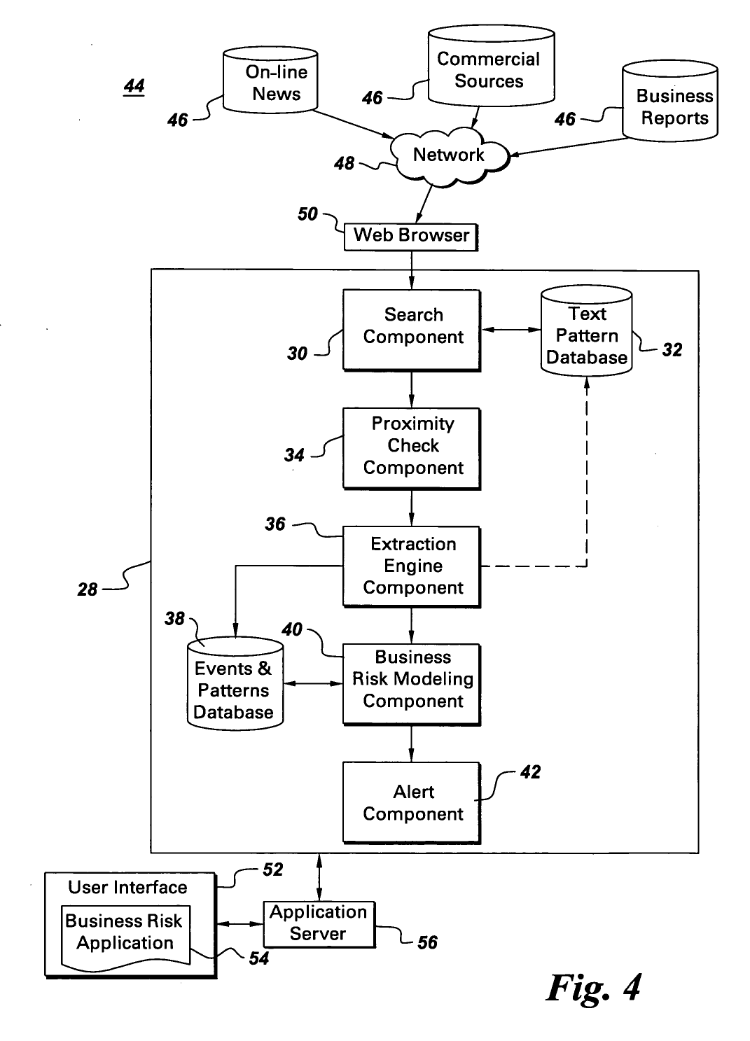

FIG. 4 shows an architectural diagram of a system 44 that implements the business risk analysis system 28 shown in FIG. 2. In FIG. 4, the business risk analysis system 28 accesses a plurality of natural language sources 46 located on a network 48 through the use of a web browser 50. The plurality of natural language sources 46 includes on-line news sources, commercial new sources, and business, trade and industry publications. Examples of on-line news sources, commercial new sources and business, trade and industry publications include YAHOO! News, FindArticles.com; WALL STREET JOURNAL, BLOOMBERG; and JOURNAL OF ACCOUNTANCY, ECONOMIST, MODERN MACHINE SHOP, etc. As mentioned above, other possible natural language sources include data stores such as DUN AND BRADSTREET, SEC's EDGAR and NEXIS-LEXIS. The network 48 is a communication network such as an electronic or wireless network that connects the business risk analysis system 28 to the plurality of natural language sources 46. The network may be a private network such as an extranet or intranet or a global network such as a WAN (e.g., Internet).

In operation, the business risk analysis system 28 acting through the search component 30 activates the web browser 50 at either predefined intervals of time or at the prompting of a user of the system 44. In particular, the search component provides the web browser 50 with target URL information for accessing the plurality of natural language sources 46 and appropriate search criteria (e.g., business entity name and keyword) for searching the sources embedded in it for qualitative business event information. The web browser 50 returns links of web pages that have articles that mention the specified business entity and keywords.

Also shown in FIG. 4 is a user interface 52 that allows the system 44 to interface with a human user such as a financial analyst and/or another operating system. For example, the user interface 52 may take the form of a keyboard, mouse and monitor. The user interface 52 further comprises a business risk application 54 that displays the results (e.g., patterns and events that match the specified search criteria, estimated probability of risk associated with an entity, links to pertinent articles, and paragraphs containing relevant qualitative business event information, etc.) of the business risk analysis system 28 to the user through an application server 56. In addition, the user can access the business risk analysis system 28 through the business risk application 54 to add pattern templates into the events and patterns database 38 and edit attributes of pattern templates already in the database. Also, the user interface 52 and business risk application 54 has the capability to permit the user to enter new target business entities into the business risk analysis system 28 for monitoring and analysis, as well as editing and deleting entities and events already in the system.

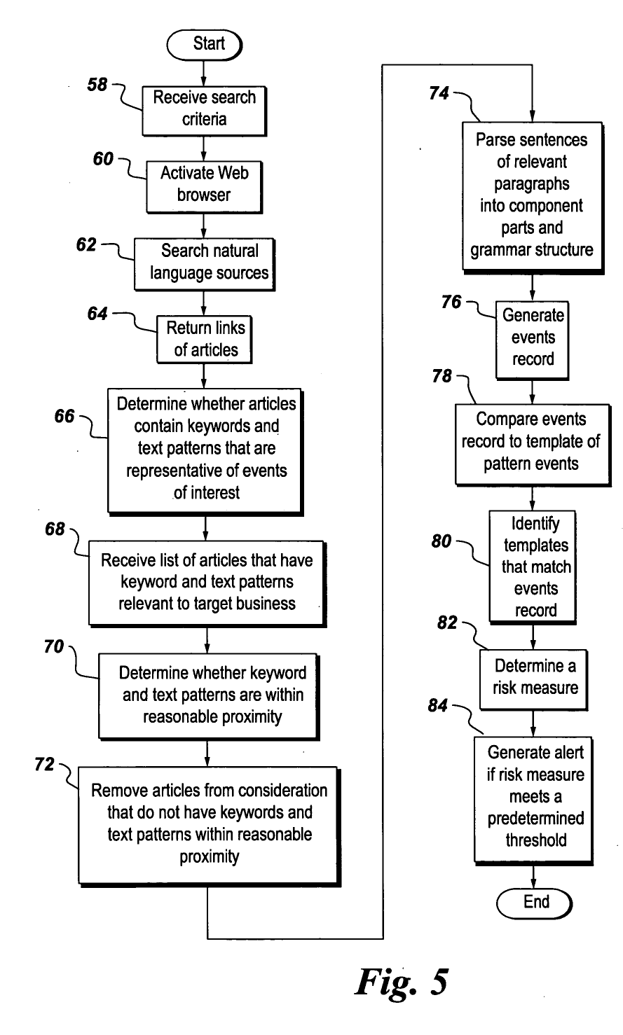

FIG. 5 is a flowchart describing the processing functions performed by the system 44 shown in FIG. 4. At 58, the search component receives the specified search criteria (e.g., business entity name and keyword) for searching the plurality of natural language sources. In this step, the user can enter the target business entity and keywords through the user interface or the search component can retrieve this information from a database. The search component then activates the web browser at 60 and provides it with the URLs of the plurality of natural language sources and search criteria. The web browser searches the plurality of natural language sources at 62 and returns links of web pages that have articles that mention the specified business entity and keywords at 64. The search component then scans each of the articles returned and determines whether they contain keywords and text patterns that are representative of events of interest for the target business entity at 66. As mentioned above, the search component accesses the text pattern database to determine whether the articles contain keywords and text patterns that are representative of events of interest for the target business entity.

The proximity check component receives a list of all of the articles that the search component determined had keywords and text patterns that were representative of events of interest for the target business entity at 68. The proximity check component then ascertains at 70 whether the keywords and text patterns in the articles are within a reasonable proximity to the target business entity. The proximity checking component removes articles from consideration that do not have keywords or text patterns within a reasonable proximity at 72.

The extraction engine component receives the relevant paragraphs from the articles that were determined to be within a reasonable proximity and parses each sentence within the received paragraphs into component parts of speech and grammar structure at 74. As mentioned above, the extraction engine component uses a grammar parsing tool and a semantic analysis tool to perform these functions. All of the information determined by the grammar parsing tool and the semantic analysis tool are put into the structured events record at 76. The events record includes information such as an event category (e.g., management change, SEC action, bankruptcy, etc.), event keywords within each sentence of an article, roles of the keywords within each sentence, relationships between the events and the target business entity and sense and direction of the events. The extraction engine component stores the events record in the events and patterns database and outputs it to the business risk model component.

The business risk model component uses the business risk model to map the events record of the target business entity to a business risk measure. At 78, the business risk model component compares the structured events record to the stored templates of pattern events. The business risk model component then identifies templates of pattern events that match the structured events record at 80. The business risk model component generates a probability of risk measure based on the degree of match between the identified templates of pattern events and the structured events record at 82. The alert component generates an alert if the risk measure reaches a predetermined threshold at 84.

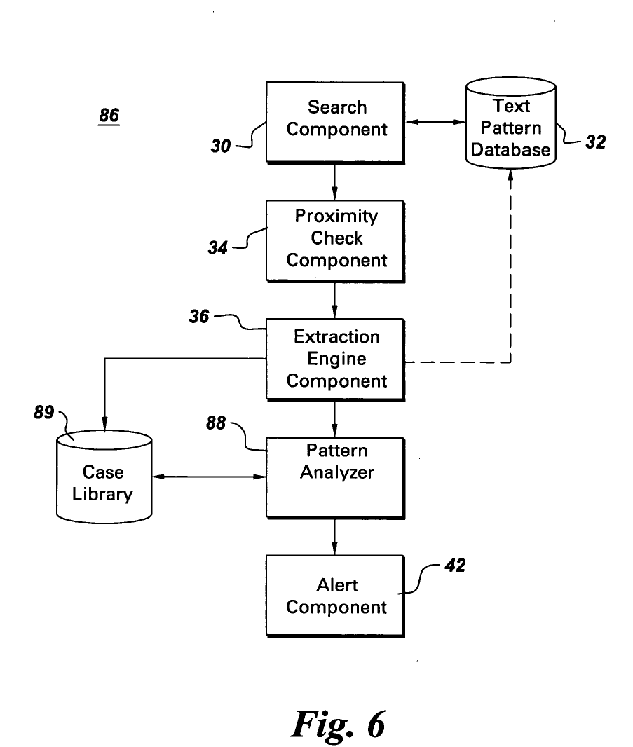

FIG. 6 shows an alternative embodiment of the business risk analysis system shown in FIG. 2. In particular, FIG. 6 shows a business risk analysis system 86 that utilizes case-based reasoning. The business risk analysis system 86 is similar to the system shown in FIG. 2, except that this embodiment includes a pattern analyzer 88 that uses case-based reasoning to determine whether the events record generated from the events extraction engine component 36 matches any cases of patterns of events stored in a case library 89. Each case in the case library 89 represents a business entity at a certain expert-defined level of risk, where each entity is represented by a set of relevant events that have occurred in the business. Each of the relevant events has a weight that indicates the importance of the event for that particular case. Although some cases will share the same events, the weights may differ, reflecting the relative importance of events per case. For initial cases, an expert can determine the weights. By default, the weight of events that are extracted for a probe case (i.e., a case not in the library) will be derived from the weight of the same events used in the cases in the case library that most closely match the probe case. For events that are not common between the probe case and a matched case, a weight can be taken from a default weight table, so that these events are not discounted in the target case. The probe case, with its updated weights, is then added to the case library for future reference.

In operation, the pattern analyzer 88 compares a probe case against cases in the case library 89 to assess business risk. In particular, the pattern analyzer 88 uses case-based reasoning to compare the similarity of the probe case to any of the cases in the case library 89. The basis of the comparison is the types of events, temporal order and proximity of events representing each case, and the weights assigned to the events. For each comparison, the pattern analyzer 88 generates weight that represents the degree of match between the probe case and the case in the case library 89. One of ordinary skill will recognize that there are well known case-based reasoning algorithms that one can use to perform these functions. If the probe case's weight reaches a predetermined threshold, then that is an indication that the target case is exhibiting a suspicious pattern that warrants further review.

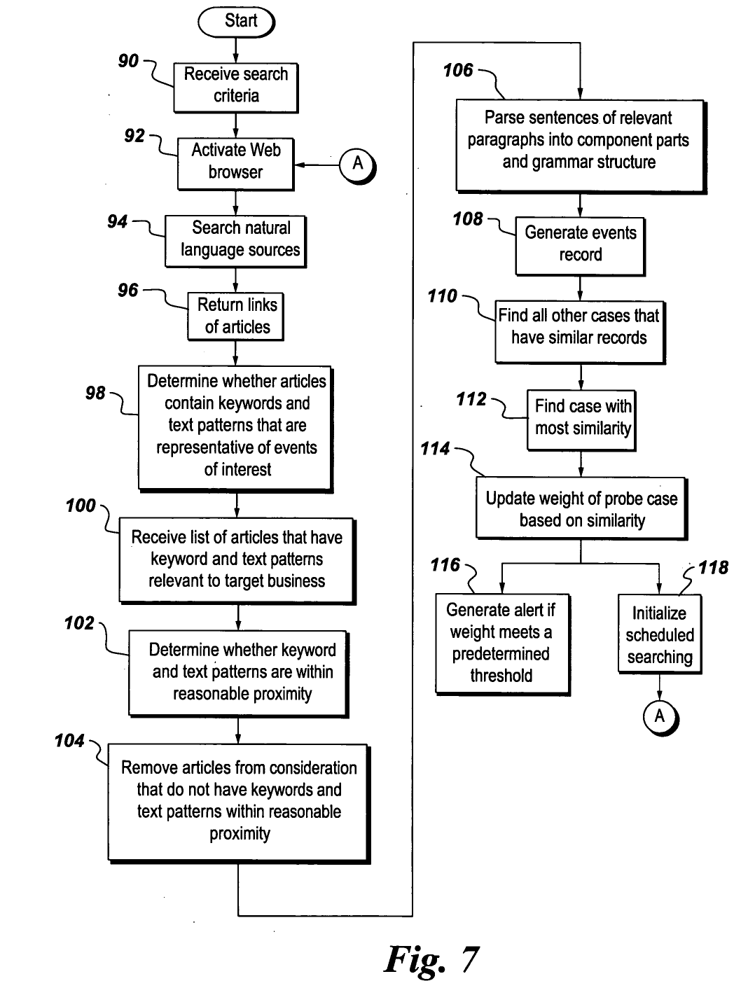

FIG. 7 is a flowchart describing the process performed by the system shown in FIG. 6. At 90, the search component receives the specified search criteria (e.g., business entity name and keyword) for searching the plurality of natural language sources. In this step, the user can enter the target business entity and keywords through the user interface or the search component can retrieve this information from a database. The search component then activates the web browser at 92 and provides it with the URLs of the plurality of natural language sources and search criteria. The web browser searches the plurality of natural language sources at 94 and returns links to web pages that have articles that mention the specified business entity and keywords at 96. The search component then scans each of the articles returned and determines whether they contain keywords and text patterns that are representative of events of interest for the target business entity at 98. As mentioned above, the search component accesses the text pattern database to determine whether the articles contain keywords and text patterns that are representative of events of interest for the target business entity.

The proximity check component receives a list of all of the articles that the search component determined had keywords and text patterns that were representative of events of interest for the target business entity at 100. The proximity check component then ascertains at 102 whether the keywords and text patterns in the articles are within a reasonable proximity to the target business entity. The proximity checking component removes articles from consideration that do not have keywords or text patterns within a reasonable proximity at 104.

The extraction engine component receives the relevant paragraphs from the articles that were determined to be within a reasonable proximity and parses each sentence within the received paragraphs into component parts of speech and grammar structure at 106. As mentioned above, the extraction engine component uses a grammar parsing tool and a semantic analysis tool to perform these functions. All of the information determined by the grammar parsing tool and the semantic analysis tool are put into the structured events record at 108. The extraction engine component stores the events record in the events and patterns database and outputs it to the pattern analyzer.

At 110, the pattern analyzer finds all other cases in the case library that are similar to the events record of the probe case. In particular, the pattern analyzer looks for overlaps of information between the events record for the target entity and the stored cases. For example, if the target case had a CEO change, an earnings restatement and an SEC investigation, then the pattern analyzer would try to find cases with one or more of these events occurring. In addition to the types of events, the pattern analyzer takes into account the temporal relationships between the events and the order of the events. The pattern analyzer then finds the case that is most similar to the probe case at 112.

The case that is most similar to the probe case becomes the basis for assessing the level of risk of the target business entity. In particular, the pattern analyzer updates the weight of the probe case based on its similarity with the case found to have the most similarity at 114. The weights of the events are used to calculate the overall risk of the scenario. Once a probe case has identified a closest match, the probe case will assume the weights for all the events in common between it and the match case. For any remaining events, it will assume the weight either of the independent event from the event weights table, or the weight that event has in the next closest match case. One skilled in the art will recognize that other weight allocation methods may be used, such as assuming all independent weights or using standard baseline combined weights. The alert component generates an alert if the updated weight reaches a predetermined threshold at 116. In addition, after the weight has been updated, then future searching for the target business entity is scheduled at 118 so that steps 92-118 may repeat.

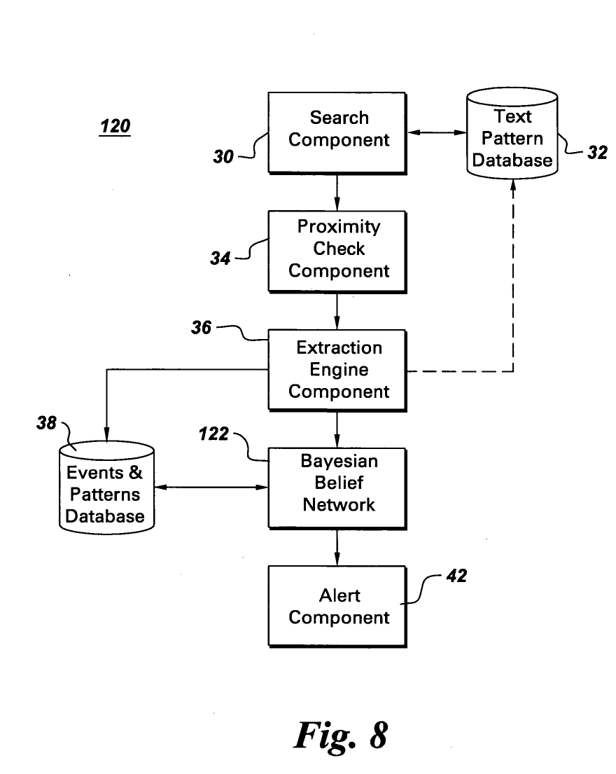

FIG. 8 shows another alternative embodiment of the business risk analysis system shown in FIG. 2. In particular, FIG. 8 shows a business risk analysis system 120 that utilizes a Bayesian belief network. The business risk analysis system 120 is similar to the system shown in FIG. 2, except that this embodiment uses a Bayesian belief network 122 to combine events observed for a target business entity with event uncertainties to determine the likelihood that the entity will enter an expert-defined level of business risk. In this embodiment, the Bayesian belief network defines various events like the ones mentioned above (e.g., defaults on credit facility or loan agreements, bankruptcy rumors, bankruptcy, debt restructure, loss of credit, target SEC actions, restatement of previously published earnings, change of auditors, management changes, layoffs, wage reductions, company restructures, refocused objectives, mergers and acquisitions, government changes and industry events that may impact a business) and the dependencies between them and the conditional probabilities involved in those dependencies. The network with its conditional probabilities can be established using the templates of pattern events stored in the events and patterns database. A person of skill in the art will recognize that the Bayesian belief network requires a large amount of historical data or expert knowledge to derive the correct prior and conditional probabilities for events and event relationships. Once the events record is received from the extraction engine component, it is mapped to the Bayesian belief network, which in turn recalculates the conditional probabilities of all of the nodes in the network according to the events listed in the record. If the probability in the inferred node reaches a predetermined threshold then the alert component will generate an alert. An example of this system could include a Bayesian belief network trying to predict bankruptcy. For a pattern of events leading to bankruptcy, the links between those events would have different conditional probabilities. For example, the conditional probability of an auditor change occurring after a CEO change would be different than the conditional probability of an auditor change occurring after an SEC investigation, and would lead to a different probability of bankruptcy. The conditional probabilities for a sequence of events would be combined to yield an overall probability of reaching bankruptcy.

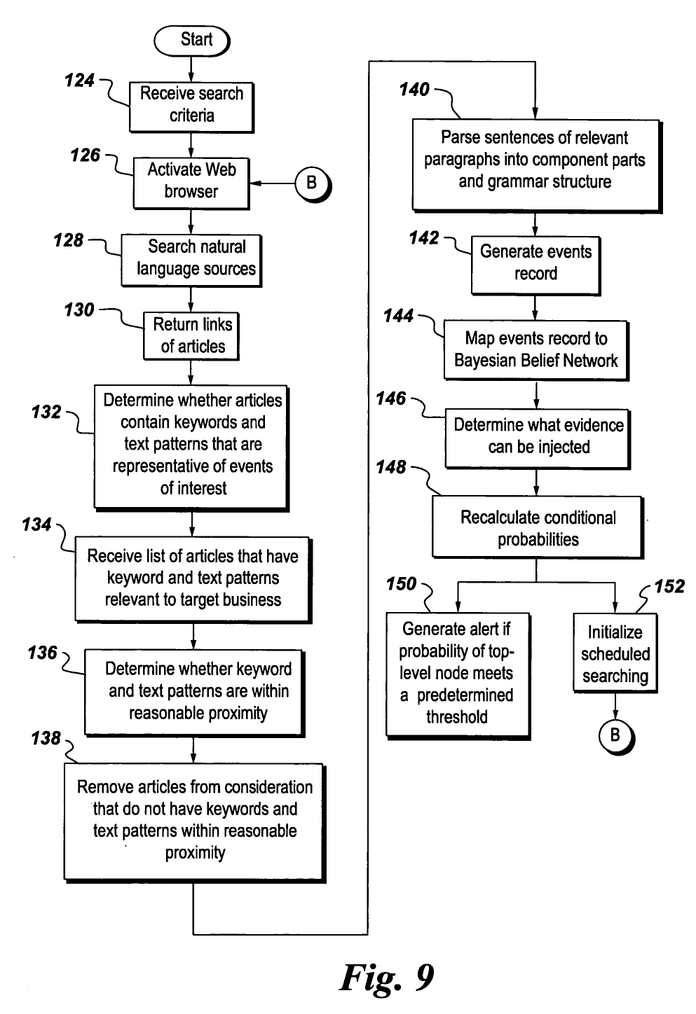

FIG. 9 is a flowchart describing the process performed by the system shown in FIG. 8. At 124, the search component receives the specified search criteria (e.g., business entity name and keyword) for searching the plurality of natural language sources. In this step, the user can enter the target business entity and keywords through the user interface or the search component can retrieve this information from a database. The search component then activates the web browser at 126 and provides it with the URLs of the plurality of natural language sources and search criteria. The web browser searches the plurality of natural language sources at 128 and returns links of web pages that have articles that mention the specified business entity and keywords at 130. The search component then scans each of the articles returned and determines whether they contain keywords and text patterns that are representative of events of interest for the target business entity at 132. As mentioned above, the search component accesses the text pattern database to determine whether the articles contain keywords and text patterns that are representative of events of interest for the target business entity.

The proximity check component receives a list of all of the articles that the search component determined had keywords and text patterns that were representative of events of interest for the target business entity at 134. The proximity check component then ascertains at 136 whether the keywords and text patterns in the articles are within a reasonable proximity to the target business entity. The proximity checking component removes articles from consideration that do not have keywords or text patterns within a reasonable proximity at 138.

The extraction engine component receives the relevant paragraphs from the articles that were determined to be within a reasonable proximity and parses each sentence within the received paragraphs into component parts of speech and grammar structure at 140. As mentioned above, the extraction engine component uses a grammar parsing tool and a semantic analysis tool to perform these functions. All of the information determined by the grammar parsing tool and the semantic analysis tool are put into the structured events record at 142. The extraction engine component stores the events record in the events and patterns database and outputs it to the Bayesian belief network.

At 144, the events record is mapped to the Bayesian belief network. The Bayesian belief network then looks at the events record to determine what evidence can be injected from the record into the network at 146. For example, if the events record indicates that there was a CEO change and the events records indicates that there is a 95% level of confidence that the record is truly indicative of a CEO change, then the Bayesian belief network will use this confidence level as an input of evidence. The Bayesian belief network then recalculates the conditional probabilities of all of the nodes in the network according to the events listed in the record and the injected evidence at 148. If the probability in the inferred node reaches a predetermined threshold then the alert component generates an alert at 150. In addition, after the conditional probabilities have been recalculated, then future searching for the target business entity is scheduled at 152 so that steps 126-152 may repeat.

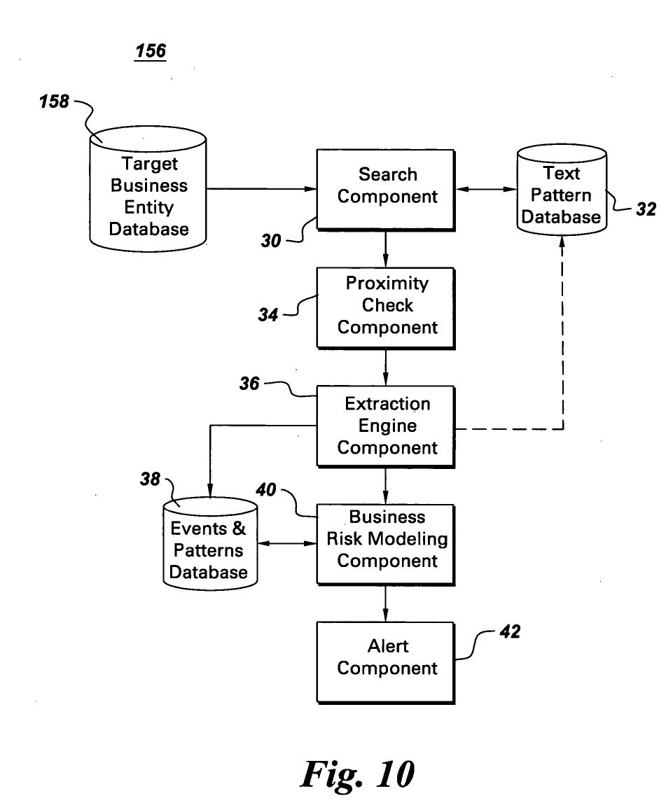

The embodiments shown in FIGS. 2, 4, 6, and 8 are suitable for both on-demand and scheduled applications. FIG. 10 shows a business risk analysis system 156 suitable for monitoring business risk of business entities on a scheduled basis. The business risk analysis system 156 is similar to the system shown in FIG. 2, except that this embodiment includes a target business entity database 158 that contains a list of business entities that an analyst can monitor for business risk. The database is preferably an XML file, however, one of skill in the art will recognize that any database that can store a list of entities is suitable for use. In this embodiment, the search component is activated on a scheduled basis to search the plurality of natural languages for qualitative business event information that relates to one of the specified target business entities. The schedule for running the search is variable and the user can initialize the system 156 to run searches on a daily, weekly or monthly basis.

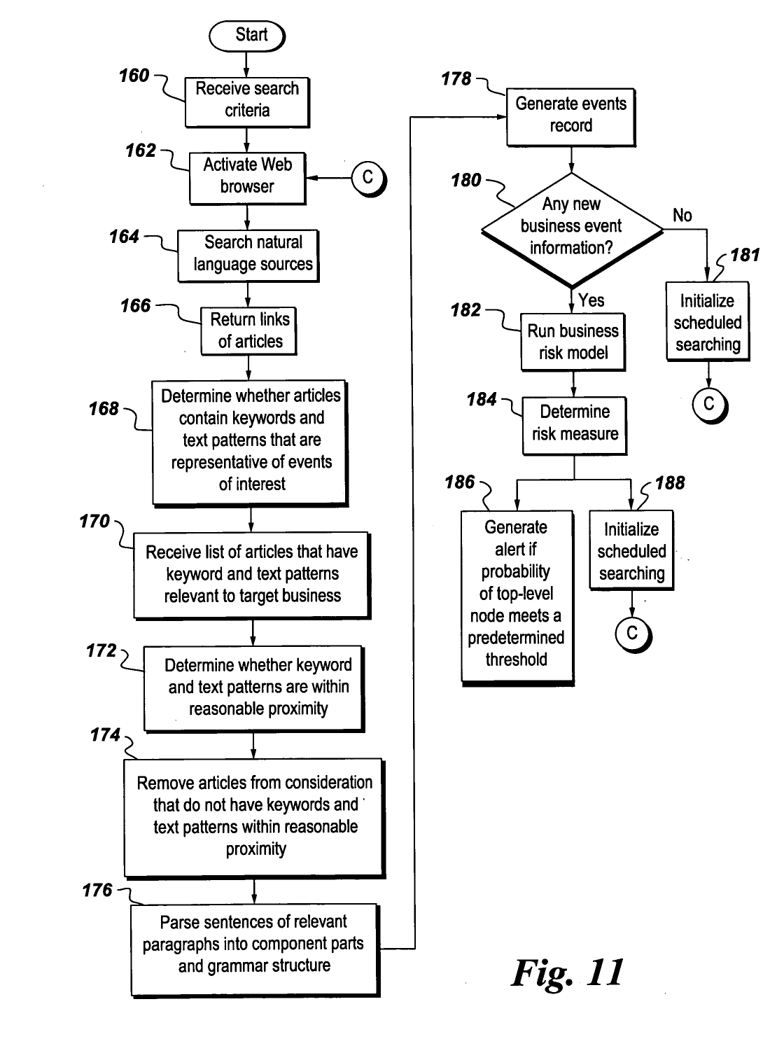

FIG. 11 is a flowchart describing the processing functions performed by the system shown in FIG. 10. When the search component determines that it is time to run a search for a specific target business entity, it retrieves the search criteria from the target business entity database at 160. The search component then activates the web browser at 162 and provides it with the URLs of the plurality of natural language sources and search criteria. The web browser searches the plurality of natural language sources at 164 and returns links to web pages that have articles that mention the specified business entity and keywords at 166. The search component then scans each of the articles returned and determines whether they contain keywords and text patterns that are representative of events of interest for the target business entity at 168. As mentioned above, the search component accesses the text pattern database to determine whether the articles contain keywords and text patterns that are representative of events of interest for the target business entity.

The proximity check component receives a list of all of the articles that the search component determined had keywords and text patterns that were representative of events of interest for the target business entity at 170. The proximity check component then ascertains at 172 whether the keywords and text patterns in the articles are within a reasonable proximity to the target business entity. The proximity checking component removes articles from consideration that do not have keywords or text patterns within a reasonable proximity at 174.

The extraction engine component receives the relevant paragraphs from the articles that were determined to be within a reasonable proximity and parses each sentence within the received paragraphs into component parts of speech and grammar structure at 176. As mentioned above, the extraction engine component uses a grammar parsing tool and a semantic analysis tool to perform these functions. All of the information determined by the grammar parsing tool and the semantic analysis tool are put into the structured events record at 178. After updating the text pattern database with the events record, the extraction engine component determines whether any new or unanalyzed qualitative business event information has been found at 180. If there is no new qualitative business event information then future searching for the target business entity is initialized at 181 so that steps 162-188 may repeat.

If there is new or unanalyzed qualitative business event information, then the business risk model is run at 182, which maps the events record of the target business entity to a business risk measure. In particular, the business risk model component compares the events record to the stored templates of pattern events and identifies templates of pattern events that match the structured events record. The business risk model component generates a probability of risk measure based on the degree of match between the identified templates of pattern events and the events record at 184. The alert component generates an alert if the risk measure reaches a predetermined threshold at 186. Also, future searching for the target business entity is scheduled at 188 so that steps 162-188 may repeat.

The foregoing flow charts and block diagrams of this invention show the functionality and operation of the various business risk systems disclosed herein. In this regard, each block/component represents a module, segment, or portion of code, which comprises one or more executable instructions for implementing the specified logical function(s). It should also be noted that in some alternative implementations, the functions noted in the blocks may occur out of the order noted in the figures or, for example, may in fact be executed substantially concurrently or in the reverse order, depending upon the functionality involved. Also, one of ordinary skill in the art will recognize that additional blocks may be added. Furthermore, the functions can be implemented in programming languages such as Java or C++; however, other languages can be used such as Perl, Haskill, or C.

The various embodiments described above comprise an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, magnetic, optical, electromagnetic, or infrared system, apparatus, or device. An illustrative, but non-exhaustive list of computer-readable mediums can include an electrical connection having one or more wires (electronic), a portable computer diskette (magnetic), RAM (magnetic), ROM (magnetic), EPROM or Flash memory (magnetic), an optical fiber (optical), and a portable compact disc read-only memory (CDROM) (optical).

Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

It is apparent that there has been provided with this invention, a method, system and computer product for analyzing business risk using event information extracted from natural language sources. While the invention has been particularly shown and described in conjunction with a preferred embodiment thereof, it will be appreciated that variations and modifications can be effected by a person of ordinary skill in the art without departing from the scope of the invention.

1. A method for analyzing business risk using qualitative business event information, comprising:
retrieving a plurality of articles each containing qualitative business event information relevant to a target business entity;
extracting a structured events record of details for the qualitative business event information from the plurality of articles; and
applying the structured events record to a business risk model that uses temporal reasoning to map qualitative business event information to business risk, wherein the business risk model determines the business risk of the target business entity based on temporal proximity and order of the qualitative business event information in the structured events record.

2. The method according to claim 1, wherein the retrieving comprises:
searching a plurality of natural language sources for articles mentioning the target business entity;
determining whether the articles contain keywords and text patterns that are representative of events of interest for the target business entity; and
ascertaining whether the keywords and text patterns in the articles are within a reasonable proximity to the target business entity.

3. The method according to claim 2, further comprising removing articles that do not have keywords or text patterns within a reasonable proximity to the target business entity.

4. The method according to claim 2, wherein the ascertaining comprises using a plurality of proximity rules to identify whether the keywords and text patterns are likely related to the target business entity.

5. The method according to claim 2, further comprising generating a confidence measure for each article ascertained to have keywords and text patterns within a reasonable proximity to the target business entity, wherein the confidence measure is an indication of the belief that the article contains an event of interest that is relevant to the target business entity.

6. The method according to claim 1, wherein the extracting comprises:
retrieving paragraphs of text containing the event information relevant to the target business entity from each of the plurality of articles;
parsing each sentence within the paragraphs into component parts of speech and grammar structure;
extracting event details and relationships between events and the target business entity from the component parts of speech and grammar structure; and
generating the structured events record from the extracted event details and relationships.

7. The method according to claim 6, wherein the extracting of event details and relationships between events and the target business entity comprises:
locating the target business entity and keywords that are representative of events of interest in each sentence;
identifying roles of the keywords in the sentences; and
determining relationships between events and the target business entity based on the roles of the keywords.

8. The method according to claim 7, further comprising identifying sense and direction of the events in the sentences.

9. The method according to claim 1, wherein the structured events record comprises an event category, event keywords within each sentence of an article, roles of the keywords within each sentence, relationships between the events and the target business entity and sense and direction of the events.

10. The method according to claim 1, wherein the applying of the structured events record to a business risk model comprises comparing the structured events record to templates of pattern events, wherein each template comprises a number and type of events that form a pattern in an event category and temporal constraints that exist between the events.

11. The method according to claim 10, further comprising identifying templates of pattern events that match the structured events record.

12. The method according to claim 11, further comprising generating a probability of risk measure based on the degree of match between the identified templates of pattern events and the structured events record.

13. The method according to claim 1, wherein the business risk model utilizes at least one of case-based reasoning and a Bayesian belief network.

14. The method according to claim 1, further comprising generating an alert when the business risk model determines that the risk of the target business entity has reached a predetermined threshold.

15. A method for analyzing business risk of a target business entity from qualitative event business information, comprising:
retrieving a plurality of articles each containing qualitative event information relevant to the target business entity, wherein the retrieved articles contain keywords and text patterns that are representative of events of interest for the target business entity and are within a reasonable proximity to the target business entity;
parsing each sentence within a paragraph of text from an article that contains keywords and text patterns into component parts of speech and grammar structure;
extracting event details and relationships between events and the target business entity from the component parts of speech and grammar structure;
generating a structured events record from the extracted event details and relationships;
comparing the structured events record to templates of pattern events, wherein each template comprises a number and type of events that form a pattern in an event category and temporal constraints that exist between the events;
using temporal based reasoning to identify templates of pattern events that match the structured events record; and
generating a probability of risk measure based on the degree of match between the identified templates of pattern events and the structured events record.

16. The method according to claim 15, wherein the retrieving comprises using a plurality of proximity rules to identify whether the keywords and text patterns in the articles are likely related to the target business entity.

17. The method according to claim 15, wherein the extracting of event details and relationships between events and the target business entity comprises:
locating the target business entity and keywords that are representative of events of interest in each sentence;
identifying roles of the keywords in the sentences; and
determining relationships between events and the target business entity based on the roles of the keywords.

18. The method according to claim 17, further comprising identifying sense and direction of the events in the sentences.

19. The method according to claim 15, wherein the structured events record comprises an event category, event keywords within each sentence of an article, roles of the keywords within each sentence, relationships between the events and the target business entity and sense and direction of the events.

20. The method according to claim 15, wherein the using of temporal based reasoning to identify templates of pattern events that match the structured events record comprises utilizing at least one of case-based reasoning and a Bayesian belief network.

21. The method according to claim 15, further comprising generating an alert when the probability of risk measure reaches a predetermined threshold.

22. A method for monitoring business risk of a target business entity using qualitative event business information, comprising:
searching a plurality of natural language sources for articles mentioning the target business entity;
retrieving a plurality of articles each containing qualitative event business information relevant to the target business entity, wherein the retrieved articles contain keywords and text patterns that are representative of events of interest for the target business entity and are within a reasonable proximity to the target business entity;
determining whether any of the retrieved articles contain unanalyzed qualitative event business information;
for articles containing unanalyzed qualitative event business information, parsing each sentence within a paragraph of text from the article into component parts of speech and grammar structure;
extracting event details and relationships between events and the target business entity from the component parts of speech and grammar structure;
generating a structured events record from the extracted event details and relationships;
comparing the structured events record to templates of pattern events, wherein each template comprises a number and type of events that form a pattern in an event category and temporal constraints that exist between the events;
using temporal based reasoning to identify templates of pattern events that match the structured events record; and
generating a probability of risk measure based on the degree of match between the identified templates of pattern events and the structured events record.

23. The method according to claim 22, wherein the extracting of event details and relationships between events and the target business entity comprises:
locating the target business entity and keywords that are representative of events of interest in each sentence;
identifying roles of the keywords in the sentences; and
determining relationships between events and the target business entity based on the roles of the keywords.

24. The method according to claim 22, wherein the structured events record comprises an event category, event keywords within each sentence of an article, roles of the keywords within each sentence, relationships between the events and the target business entity and sense and direction of the events.

25. The method according to claim 22, wherein the using of temporal based reasoning to identify templates of pattern events that match the structured events record comprises utilizing at least one of case-based reasoning and a Bayesian belief network.

26. The method according to claim 22, further comprising generating an alert when the probability of risk measure reaches a predetermined threshold.

27. A system for analyzing business risk from qualitative business event information, comprising:
a search component configured to search and retrieve a plurality of articles each containing qualitative business event information relevant to a target business entity;
an extraction engine component configured to extract a structured events record of details of the qualitative business event information retrieved from the plurality of articles; and
a business risk model component configured to map the structured events record of the target business entity to a business risk measure, wherein the business risk model component determines the business risk measure based on temporal proximity and order of the qualitative business event information in the structured events record.

28. The system according to claim 27, further comprising a text pattern database defining a set of keywords and text patterns that are representative of events of interest.

29. The system according to claim 28, wherein the search component is configured to search a plurality of natural language sources for articles mentioning the target business entity and access the text pattern database to determine whether the articles contain keywords and text patterns that are representative of events of interest for the target business entity.

30. The system according to claim 29, further comprising a proximity checking component configured to ascertain whether the keywords and text patterns in the articles are within a reasonable proximity to the target business entity.

31. The system according to claim 30, wherein the proximity checking component is configured to remove articles that do not have keywords or text patterns within a reasonable proximity to the target business entity.

32. The system according to claim 30, wherein the proximity checking component is configured to use a plurality of proximity rules to identify whether the keywords and text patterns are likely related to the target business entity.

33. The system according to claim 30, wherein the proximity checking component is configured to generate a confidence measure for each article ascertained to have keywords and text patterns within a reasonable proximity to the target business entity, wherein the confidence measure is an indication of the belief that the article contains an event of interest that is relevant to the target business entity.

34. The system according to claim 27, wherein the extraction engine component comprises a grammar parsing tool configured to receive paragraphs of text containing the event information relevant to a target business entity from each of the plurality of articles and parse each sentence within the paragraphs into component parts of speech and grammar structure.

35. The system according to claim 34, further comprising a semantic analysis tool configured to extract event details and relationships between events and the target business entity from the component parts of speech and grammar structure.

36. The system according to claim 35, wherein the semantic analysis tool is configured to locate the target business entity and keywords that are representative of events of interest in each sentence, identify roles of the keywords in the sentences, and determine relationships between events and the target business entity based on the roles of the keywords.

37. The system according to claim 36, wherein the semantic analysis tool is configured to identify sense and direction of the events in the sentences.

38. The system according to claim 27, wherein the structured events record comprises an event category, event keywords within each sentence of an article, roles of the keywords within each sentence, relationships between the events and the target business entity and sense and direction of the events.

39. The system according to claim 27, further comprising a pattern events database that comprises templates of pattern events, wherein each template comprises a number and type of events that form a pattern in an event category and temporal constraints that exist between the events.

40. The system according to claim 39, wherein the business risk model component is configured to compare the structured events record to the templates of pattern events and identify templates of pattern events that match the structured events record.

41. The system according to claim 40, wherein the business risk model component is configured to generate a probability of risk measure based on the degree of match between the identified templates of pattern events and the structured events record.

42. The system according to claim 27, wherein the business risk model component utilizes at least one of case-based reasoning and a Bayesian belief network.

43. The system according to claim 27, further comprising an alert component configured to generate an alert when the business risk model component determines that the risk of the target business entity has reached a predetermined threshold.

44. A system for analyzing business risk of a target business entity from qualitative event business information, comprising:
a text pattern database defining a set of keywords and text patterns that are representative of events of interest;
a search component configured to search a plurality of natural language sources and retrieve a plurality of articles each containing keywords and text patterns defined in the text pattern database;
an extraction engine component configured to extract a structured events record from the plurality of articles, wherein the extraction engine component comprises a grammar parsing tool configured to receive paragraphs of text containing the keywords and text patterns from each of the plurality of articles and parse each sentence within the paragraphs into component parts of speech and grammar structure; and a semantic analysis tool configured to extract event details and relationships between events and the target business entity from the component parts of speech and grammar structure;
a pattern events database that comprises templates of pattern events, wherein each template comprises a number and type of events that form a pattern in an event category and temporal constraints that exist between the events; and
a pattern analyzer configured to use temporal reasoning to compare the structured events record to the templates of pattern events and identify templates of pattern events that match the structured events record.

45. The system according to claim 44, further comprising a proximity checking component configured to ascertain whether the keywords and text patterns in the retrieved articles are within a reasonable proximity to the target business entity.

46. The system according to claim 45, wherein the proximity checking component is configured to remove articles that do not have keywords or text patterns within a reasonable proximity to the target business entity.

47. The system according to claim 45, wherein the proximity checking component is configured to use a plurality of proximity rules to identify whether the keywords and text patterns are likely related to the target business entity.

48. The system according to claim 44, wherein the semantic analysis tool is configured to locate the target business entity and keywords in each sentence, identify roles of the keywords in the sentences, and determine relationships between events and the target business entity based on the roles of the keywords.

49. The system according to claim 48, wherein the semantic analysis tool is configured to identify sense and direction of the events.

50. The system according to claim 44, wherein the structured events record comprises an event category, event keywords within each sentence of an article, roles of the keywords within each sentence, relationships between the events and the target business entity and sense and direction of the events.

51. The system according to claim 44, wherein the pattern analyzer is configured to generate a probability of risk measure based on the degree of match between the identified templates of pattern events and the structured events record.

52. The system according to claim 44, wherein the pattern analyzer utilizes at least one of case-based reasoning and a Bayesian belief network.

53. The system according to claim 44, further comprising an alert component configured to generate an alert when the pattern analyzer determines that the risk of the target business entity has reached a predetermined threshold.

54. A computer-readable medium storing computer instructions for instructing a computer system to analyze business risk using qualitative business event information, the computer instructions comprising:
retrieving a plurality of articles each containing qualitative business event information relevant to a target business entity;
extracting a structured events record of details for the qualitative business event information from the plurality of articles; and
applying the structured events record to a business risk model that uses temporal reasoning to map qualitative business event information to business risk, wherein the business risk model component determines the business risk of the target business entity based on temporal proximity and order of the qualitative business event information in the structured events record.

55. The computer-readable medium according to claim 54, wherein the retrieving comprises instructions for:
searching a plurality of natural language sources for articles mentioning the target business entity;
determining whether the articles contain keywords and text patterns that are representative of events of interest for the target business entity; and
ascertaining whether the keywords and text patterns in the articles are within a reasonable proximity to the target business entity.

56. The computer-readable medium according to claim 55, further comprising instructions for removing articles that do not have keywords or text patterns within a reasonable proximity to the target business entity.

57. The computer-readable medium according to claim 55, wherein the ascertaining comprises instructions for using a plurality of proximity rules to identify whether the keywords and text patterns are likely related to the target business entity.

58. The computer-readable medium according to claim 55, further comprising instructions for generating a confidence measure for each article ascertained to have keywords and text patterns within a reasonable proximity to the target business entity, wherein the confidence measure is an indication of the belief that the article contains an event of interest that is relevant to the target business entity.

59. The computer-readable medium according to claim 54, wherein the extracting comprises instructions for:
retrieving paragraphs of text containing the event information relevant to the target business entity from each of the plurality of articles;
parsing each sentence within the paragraphs into component parts of speech and grammar structure;
extracting event details and relationships between events and the target business entity from the component parts of speech and grammar structure; and
generating the structured events record from the extracted event details and relationships.

60. The computer-readable medium according to claim 59, wherein the extracting of event details and relationships between events and the target business entity comprises instructions for:
locating the target business entity and keywords that are representative of events of interest in each sentence;
identifying roles of the keywords in the sentences; and
determining relationships between events and the target business entity based on the roles of the keywords.

61. The computer-readable medium according to claim 60, further comprising instructions for identifying sense and direction of the events in the sentences.

62. The computer-readable medium according to claim 54, wherein the structured events record comprises an event category, event keywords within each sentence of an article, roles of the keywords within each sentence, relationships between the events and the target business entity and sense and direction of the events.

63. The computer-readable medium according to claim 54, wherein the applying of the structured events record to a business risk model comprises instructions for comparing the structured events record to templates of pattern events, wherein each template comprises a number and type of events that form a pattern in an event category and temporal constraints that exist between the events.

64. The computer-readable medium according to claim 63, further comprising instructions for identifying templates of pattern events that match the structured events record.

65. The computer-readable medium according to claim 64, further comprising instructions for generating a probability of risk measure based on the degree of match between the identified templates of pattern events and the structured events record.

66. The computer-readable medium according to claim 54, wherein the business risk model utilizes at least one of case-based reasoning and a Bayesian belief network.

67. The computer-readable medium according to claim 54, further comprising instructions for generating an alert when the business risk model determines that the risk of the target business entity has reached a predetermined threshold.

68. A computer-readable medium storing computer instructions for instructing a computer system to analyze business risk of a target business entity from qualitative event business information, the computer instructions comprising:
retrieving a plurality of articles each containing qualitative event information relevant to the target business entity, wherein the retrieved articles contain keywords and text patterns that are representative of events of interest for the target business entity and are within a reasonable proximity to the target business entity;
parsing each sentence within a paragraph of text from an article that contains keywords and text patterns into component parts of speech and grammar structure;
extracting event details and relationships between events and the target business entity from the component parts of speech and grammar structure;
generating a structured events record from the extracted event details and relationships;
comparing the structured events record to templates of pattern events, wherein each template comprises a number and type of events that form a pattern in an event category and temporal constraints that exist between the events;
using temporal based reasoning to identify templates of pattern events that match the structured events record; and
generating a probability of risk measure based on the degree of match between the identified templates of pattern events and the structured events record.

69. The computer-readable medium according to claim 68, wherein the retrieving comprises instructions for using a plurality of proximity rules to identify whether the keywords and text patterns in the articles are likely related to the target business entity.

70. The computer-readable medium according to claim 68, wherein the extracting of event details and relationships between events and the target business entity comprises instructions for:
locating the target business entity and keywords that are representative of events of interest in each sentence;
identifying roles of the keywords in the sentences; and
determining relationships between events and the target business entity based on the roles of the keywords.

71. The computer-readable medium according to claim 70, further comprising instructions for identifying sense and direction of the events in the sentence.

72. The computer-readable medium according to claim 68, wherein the structured events record comprises an event category, event keywords within each sentence of an article, roles of the keywords within each sentence, relationships between the events and the target business entity and sense and direction of the events.

73. The computer-readable medium according to claim 68, wherein the using of temporal based reasoning to identify templates of pattern events that match the structured events record comprises instructions for utilizing at least one of case-based reasoning and a Bayesian belief network.

74. The computer-readable medium according to claim 68, further comprising instructions for generating an alert when the probability of risk measure reaches a predetermined threshold.
